(19) United States
(12) Patent Application Publication
(10) Pub. No.: US 2015/0244966 A1
(43) Pub. Date: Aug. 27, 2015

(54) ENHANCED OUTPUT FOR MULTI-MEDIA DEVICE

(71) Applicant: Nikaise Elan, Delray Beach, FL (US)

(72) Inventor: Nikaise Elan, Delray Beach, FL (US)

(21) Appl. No.: 14/190,089

(22) Filed: Feb. 25, 2014

(51) Int. Cl. H04N 5/64; H04R 1/02

(52) U.S. Cl. CPC H04N 5/642; H04R 1/028; H04R 2499/15

(57) ABSTRACT

A support for a multi-media device, such as a television, is provided. The support can include a first lateral element housing a first speaker and a second lateral element housing a second speaker. The support can further include a connecting element joining the first and second lateral elements. The first and second lateral elements can be spaced to receive the multi-media device between them. The support can include a device connector configured to operatively connect to a corresponding support connector on the multi-media device. When the device connector and the support connector are operatively connected, output from the multi-media device is output from the support. For instance, audio output from the multi-media device can be output from the first speaker and/or second speaker of the support.

### FIELD

Embodiments relate in general to multi-media devices and, more particularly, to multi-media devices that provide audio output.

### BACKGROUND

Televisions provide audio output by one or more speakers integrated into the television unit. A user is limited to the direction and quality of the audio output based on the design and construction of the television. However, the audio output of the television may not be in a desired direction or of optimal quality. Further, a television may not provide one or more ancillary functionalities desired by a user. In such case, one or more peripheral devices are connected to the television to provide the desired functionalities. However, the connection of multiple peripheral device may become overly cluttered and detract from the appearance of the television. Thus, there is a need for apparatus, systems and/or methods that can minimize such concerns.

### SUMMARY

In one respect, arrangements are directed to a support for a multi-media device. The support includes a first lateral element housing a first speaker. The support also includes a second lateral element housing a second speaker. The support further includes a connecting element joining the first and second lateral elements. The connecting element can be angled at substantially 90 degrees relative to at least one of the first and second lateral elements.

The first and second lateral elements are spaced to receive a multi-media device in the spacing between them. The first and second lateral elements are configured to engage the multi-media device.

The first and second lateral elements can include a respective inwardly facing lateral surface. In at least some arrangements, at least one of the inwardly facing lateral surfaces can be configured to interlockingly engage a multi-media device. In one implementation, the at least one of the inwardly facing lateral surfaces includes a male portion, and the multi-media device can include a respective female portion. In such case, the male portion can interlockingly engage the respective female portion of a multi-media device. In another implementation, the at least one of the inwardly facing lateral surfaces includes a female portion, and the multi-media device can include a respective male portion. In such case, the female portion can interlockingly engage a respective male portion of a multi-media device.

The first lateral element and the second lateral element can each include a respective forward facing surface. In one implementation, at least one of the forward facing surfaces can be convex. In one arrangement, the first speaker can include a subspeaker and a base speaker. Alternatively or in addition, the second speaker can include a subspeaker and a base speaker. The connecting element can be removably attached to the first lateral element and/or the second lateral element. The support can include a connector configured to engage a respective connector provided on a multi-media device.

In another respect, arrangements are directed to a multi-media system. The system includes a multi-media device, which can be, for example, a television. The multi-media device can include a support connector. The system can further include a support for the multi-media device. The support can include a first lateral element housing a first speaker, a second lateral element housing a second speaker, and a connecting element joining the first and second lateral elements. In some arrangements, the connecting element can be removably attached to at least one of the first and second lateral elements.

The first and second lateral elements can be spaced to receive the multi-media device between them. The support can include a device connector configured to operatively connect to the support connector on the multi-media device. The device connector and the support connector can be operatively connected so that audio output from the multi-media device is output from the first speaker and/or second speaker of the support.

The first and second lateral elements can include a respective forward facing surface. At least one of the forward facing surfaces can be convex. The multi-media device can include a display. The display can have an associated curvature. The curvature of the display can substantially match an associated curvature of the at least one convex forward facing surface.

Each of the first and second lateral elements can include a respective inwardly facing lateral surface. At least one of the inwardly facing lateral surfaces can be configured to interlockingly engage the multi-media device. For instance, at least one of the inwardly facing lateral surfaces can include a male portion. The multi-media device can include a first lateral side and a second lateral side. A respective one of the first and seconds lateral sides can include a female portion corresponding to the male portion. The male portion can be received the female portion. Thus, the multi-media device and the support can be interlockingly engaged.

As another example, one of the inwardly facing lateral surfaces can include a female portion. The multi-media device can include a first lateral side and a second lateral side. A respective one of the first and seconds lateral sides can include a male portion corresponding to the female portion. The male portion can be received the female portion. Thus, the multi-media device and the support can be interlockingly engaged.

In a further respect, arrangements are directed to a method for a multi-media device. In one or more implementations, the multi-media device can be a television. The multi-media device can include a support connector. A support for the multi-media device can be provided. The support including a first lateral element housing a first speaker, a second lateral element housing a second speaker, and a connecting element joining the first and second lateral elements. The first and second lateral elements can be spaced to receive the multi-media device between them. The support can include a device connector configured to operatively connect to the support connector on the multi-media device.

The method includes bringing the multi-media device and the support into engagement with each other such that the device connector and the support connector are operatively connected. The method also includes outputting on the support an output from the multi-media device. Outputting an output from the multi-media device on the support can include outputting on the support an audio output from the multi-media device.

### BRIEF DESCRIPTION OF THE DRAWINGS

FIG. 1 is an example of a system for a multi-media device.

FIG. 2 is an example of a multi-media device.

FIG. 3 is an example of a front view of a support for a multi-media device.

FIG. 4 is an example of a top view of the support for a multi-media device.

FIG. 5 is an example of a first side view of the support for a multi-media device.

FIG. 6 is an example of a second side view of the support for a multi-media device.

FIG. 7 is an example of a front view of the multi-media device in combination with the support.

FIG. 8 is an example of a top view of the multi-media device in combination with the support.

FIG. 9 is an example of an engagement between the multi-media device and the support.

FIG. 10 is an example of an engagement between the multi-media device and the support.

FIG. 11 is an example of an engagement between the multi-media device and the support.

FIG. 12 is an example of a remote control device.

### DETAILED DESCRIPTION

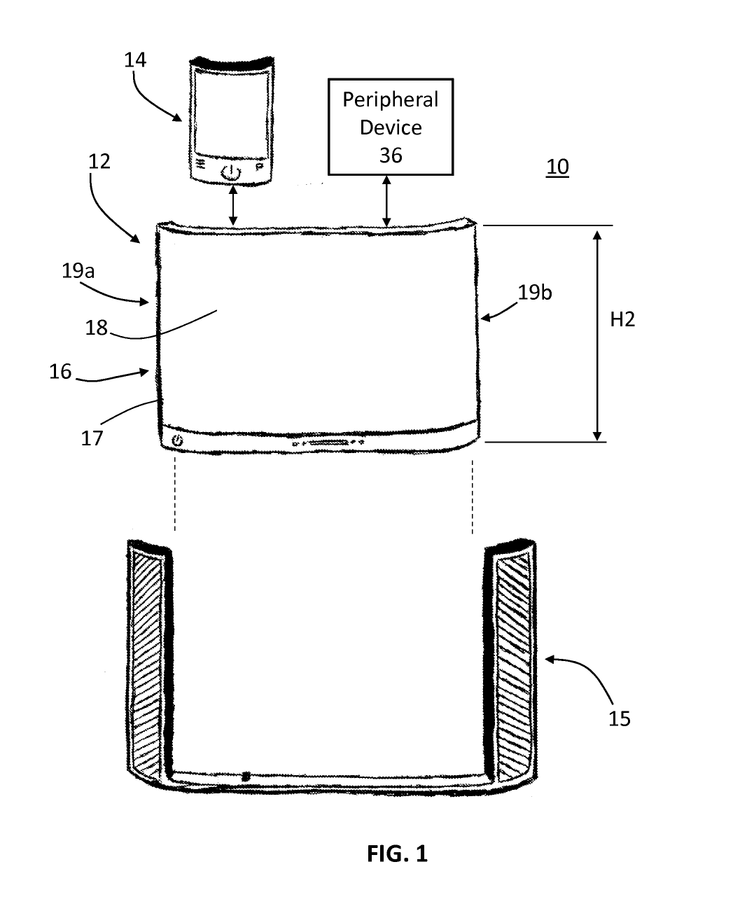

Arrangements described herein relate to systems, methods and apparatus for multi-media devices to provide enhanced output. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of embodiments and aspects herein. Arrangements are shown in FIGS. 1-12, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an exemplary system 10 is shown. The system 10 can include a multi-media device 12, a remote control device 14, and a multi-media support 15. These and other possible components of the system 10 will be described in turn below.

The multi-media device 12 can be any device that is at least partially powered by electrical energy and that can present one or more forms of content to a user. Examples of such content forms can include text, audio, video, animation, still images and/or interactivity. The different content forms may be presented simultaneously or at different times on the multi-media device 12. In one embodiment, the multi-media device 12 can be a television 16, smart TV or connected TV. A smart TV or connected TV is a television set with internet capabilities integrated therein. The multi-media device 12 can include a display 18 for presentation of content to a user. The display 18 can be any suitable type of display, such as a liquid crystal display (LCD), a light-emitting diode (LED) display or a plasma display panel (PDP). In some instances, the display 18 can be any suitable high definition display.

The multi-media device 12 can have a housing 17 including a first lateral side 19a and a second lateral side 19b. The first and second lateral sides 19a, 19b can be substantially parallel to each other. As used herein, the term “substantially” includes exactly the term it modifies and slight variations therefrom. Thus, the term “substantially parallel” means exactly parallel and slight variations therefrom.

In some implementations that display 18 of the multi-media device 12 can be substantially flat. In other implementations, the display 18 of the multi-media device 12 can be curved, as is shown in FIG. 1. The curvature of the display 18 can occur across the width of the display from about the first lateral side 19a to about the second lateral side 19b. In some instances, the display 18 can span substantially the entire width between the first lateral side 19a and the second lateral side 19b of the multi-media device 12, as is shown in FIG. 1.

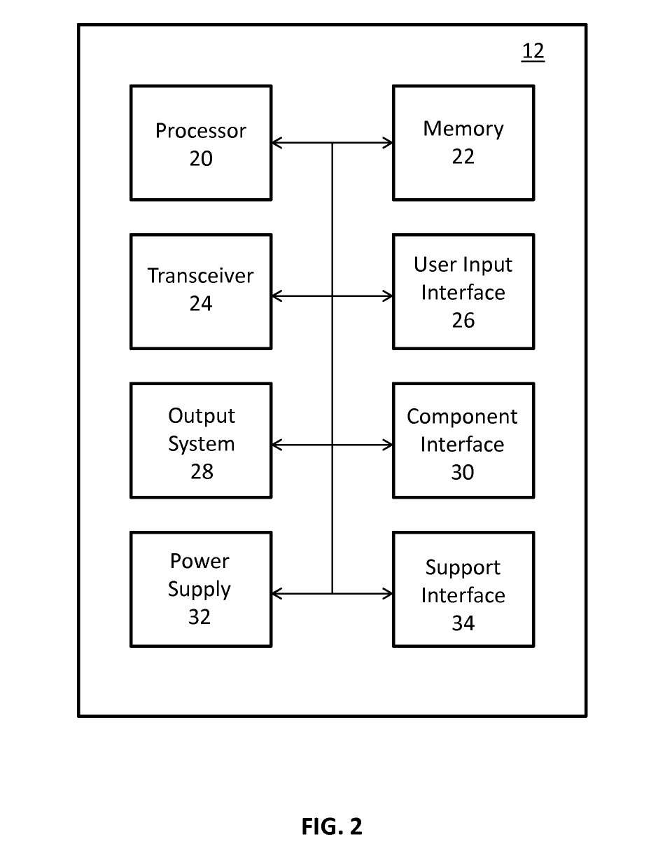

FIG. 2 shows an example of the multi-media device 12 and at least some of the components of the multi-media device 12. The multi-media device 12 can include a processor 20. The processor 20 may be implemented with one or more general-purpose and/or special-purpose processors. Examples of suitable processors include microprocessors, microcontrollers, DSP processors, and other circuitry that can execute software.

The multi-media device 12 can include memory 22 for storing various types of data. The memory 22 can include volatile and/or non-volatile memory. Examples of suitable memory 22 may include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The memory 22 can be operatively connected to the processor 20 for use thereby. The term “operatively connected” can include direct or indirect connections, including connections without direct physical contact.

The multi-media device 12 can be operatively connected to the remote control device 14 in any suitable manner, including by a network. The term “network” can include one or more components designed to transmit and/or receive information from one source to another. The transmission can be achieved in any suitable manner, such as by a hardwire connection or wirelessly. The multi-media device 12 can further include one or more transceivers 24. The transceiver 24 can be operatively connected to the processor 20 and/or the memory 22. In one embodiment, the transceiver 24 can be a wireless transceiver. Any suitable wireless transceiver can be used to wirelessly access a network or access point to transmit and receive data. The transceiver 24 may use any one of a number of wireless technologies. Examples of suitable transceivers include a cellular transceiver, a broadband internet transceiver, a local area network (LAN) transceiver, a wide area network (WAN) transceiver, a wireless local area network (WLAN) transceiver, a personal area network (PAN) transceiver, a body area network (BAN) transceiver, a WiFi transceiver, a WiMax transceiver, a Bluetooth transceiver, a 3G transceiver, a 4G transceiver, a ZigBee transceiver, a WirelessHART transceiver, a MiWi transceiver, an IEEE 802.11 transceiver, an IEEE 802.15.4 transceiver, or a Near Field Communication (NFC) transceiver, just to name a few possibilities.

The transceiver 24 can include any wireless technology developed in the future. In other exemplary embodiments, the multi-media device 12 may include one or more additional wireless transceivers (not shown) for accessing further wireless networks not accessible using the wireless transceiver 24. The multi-media device 12, including the transceiver 24, may communicate with an internet-based network according to any suitable communication protocols, including, for example, the Transmission Control Protocol and the Internet Protocol (TCP/IP), Transmission Control Protocol (TCP), User Datagram Protocol (UDP) and Universal Plug and Play (UPNP), just to name a few possibilities.

While much of the above discussion has been directed to embodiments in which the transceiver 24 is a wireless transceiver, it will be understood that embodiments are not limited to wireless transceivers. Indeed, the transceiver 24 may be configured for wired network connections.

The multi-media device 12 can include a user input interface 26 for receiving input from a user. Any suitable user input interface 26 can be provided, including, for example, a keypad, display, touch screen, button, joystick, mouse, microphone or combinations thereof. The multi-media device 12 can include an output system 28 for presenting information to the user. The output system 28 can include the display 18. The output system 28 can also include an audio interface (not shown) that can include a microphone, earphone and/or speaker.

The multi-media device 12 may include a component interface 30. Additional elements can be operatively connected to the component interface 30, including, for example, a universal serial bus (USB) interface. The multi-media device 12 can provide a support interface 34 configured for operative connection to a respective element of the multi-media support 15, as will be described in more detail below. The support interface 34 can be any suitable type of connector. For instance, the support interface 34 can be any suitable type of audio connector.

The multi-media device 12 may include a power supply 32, which may be an internal or external source. As is shown in FIG. 1, the processor 20, the memory 22, the transceiver 24, the user input system 26, the output system 28, the component interface 30, the power supply 32 and/or the support interface 34 can be operatively connected in any suitable manner.

In one or more arrangements, the multi-media device 12 can be configured to display application software on the display 18. Application software is any computer software that is configured to help a user to perform one or more specific tasks. The application software can be for any purpose, including, reference, business, entertainment, education, and communication, just to name a few possibilities. The application software can be downloaded directly by the multi-media device 12, such as by transceiver 24. The downloaded application software can be stored directly on the multi-media device 12, such as in memory 22.

In some instances, the multi-media device 12 itself may not be able to download, access, execute and/or store application software. In such cases, a peripheral device 36 can be operatively connected to the multi-media device 12. The peripheral device 36 can be configured to download, access, execute and/or store application software. In one embodiment, the peripheral device 36 can be a set-top box or set-top unit. The peripheral device 36 can also be a Blu-ray player or a game console. The peripheral device 36 can be any device that can operatively connect to a multi-media device 12 to provide content or application software programs thereto. The multi-media device 12 can access and/or execute application software resident on the peripheral device 36.

The peripheral device 36 can include a processor (not shown), memory (not shown), a transceiver (not shown), a user input interface (not shown), an output system (not shown), a component interface (not shown) and/or a power supply (not shown). The description of the processor 20, memory 22, the transceiver 24, the user input interface 26, the output system 28, the component interface 30 and the power supply 32 made above in connection with the multi-media device 12 is equally applicable to the similar components of the peripheral device 36. The peripheral device 36 can be operatively connected to the multi-media device 12 in any suitable manner, including, for example, by hardwire or wireless connections. In one or more embodiments, the peripheral device 36 can be integrated into the support 15.

In some instances, the application software can be stored in a remote source, such as a server or network. The application software can be accessed from the remote source by the multi-media device 12, the peripheral device 36 and/or the multi-media support 15. The application software may be executed on the remote source, the multi-media device 12, the peripheral device 36 and/or the multi-media support 15.

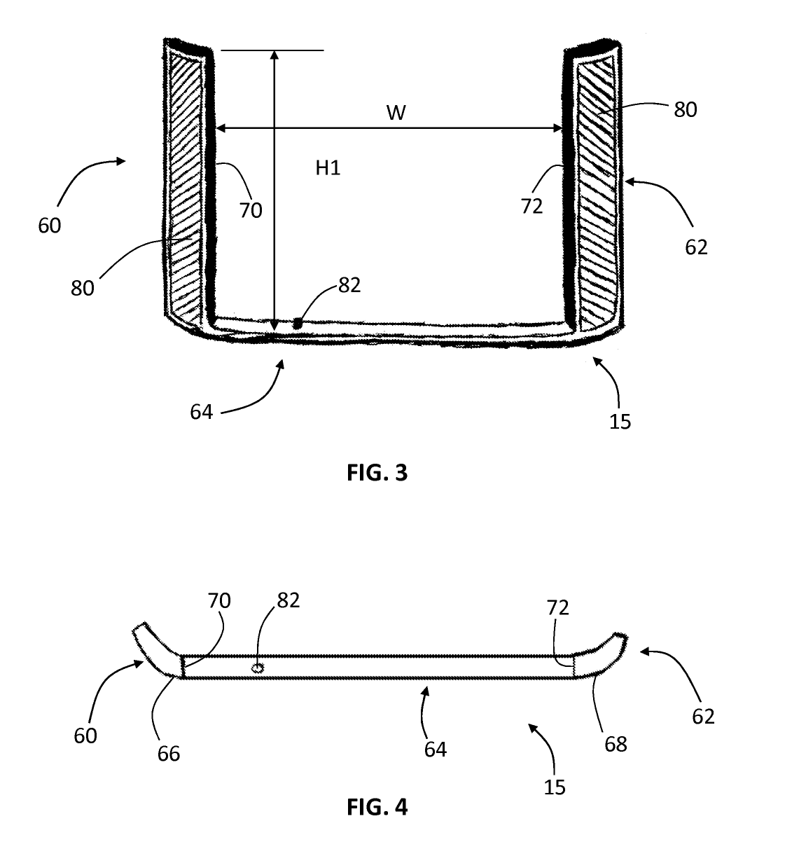

An example of the multi-media support 15 is shown in FIGS. 3-6. The multi-media support 15 can include a first lateral element 60 and/or a second lateral element 62. The first and second lateral elements 60, 62 can be joined by a connecting element 64. The first and second lateral elements 60, 62 and the connecting element 64 can collectively be substantially U-shaped, as is shown in FIG. 3, or any other suitable shape. The first and second lateral elements 60, 62 and the connecting element 64 can be formed as a unitary structure. Alternatively, at least one of these elements can be formed separately and attached to the other respective elements. In one implementation, the lateral elements 60, 62 can be removably attached to the connecting element 64.

The first and second lateral elements 60, 62 can extend at substantially 90 degrees relative to the connecting element 64. In one implementation, the first and second lateral elements 60, 62 can extend substantially vertically, and the connecting element 65 can extend substantially horizontally. Such orientations can be realized when the support 15 is supported on a surface in its normal position. The first and second lateral elements 60, 62 can be substantially parallel to each other. The first and second lateral elements 60, 62 can be substantially identical to each other or they can be different in one or more respects.

The first and second lateral elements 60, 62 can have any suitable size and/or shape. In one implementation, the first and second lateral elements 60, 62 can be generally rectangular. In other implementations, the first and second lateral elements 60, 62 can be generally curved or arcuate, as is shown in FIGS. 3-4. Each of the first and second lateral elements 60, 62 can have a respective forward facing surface 66, 68. In one or more implementations, at least one of the forward facing surfaces 66, 68 can be substantially concave. In one or more implementations, at least one of the forward facing surfaces 66, 68 can be substantially convex, as is shown in FIG. 4. Thus, the at least one of the forward facing surfaces 66, 68 can have an associated curvature. The curvature of the at least one convex forward facing surface can substantially match the associated curvature of the display 18 of the multi-media device 12. In one or more implementations, at least one of the forward facing surfaces 66, 68 can be substantially planar.

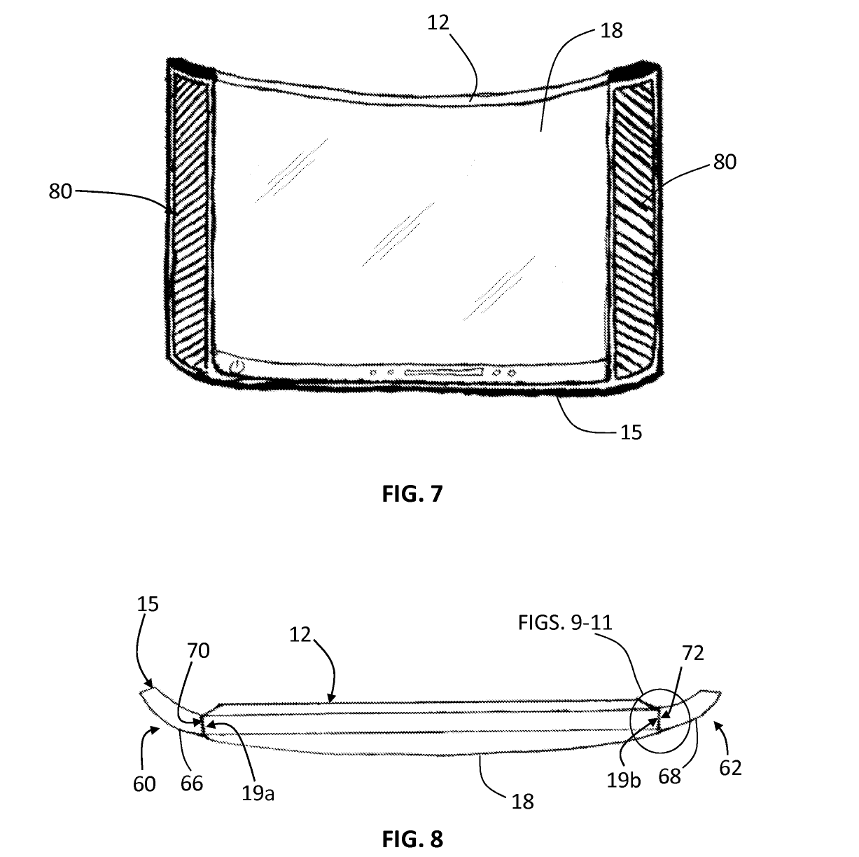

Each of the first and second lateral elements 60, 62 can have a respective inwardly facing lateral surface 70, 72. The first and second lateral elements 60, 62 can be spaced from each other such that a spacing W (FIG. 3) is formed therebetween. The spacing W can be sized to receive the multi-media device 12. The distance H1 (FIG. 3) between an upper surface of the connecting element 64 and the top of at least one of first and second lateral elements 60, 62 can be substantially identical to the height H2 (FIG. 1) of the multi-media device 12. In such case, the top of the multi-media device 12 can be substantially flush with the top of the first and/or second lateral elements 60, 62, as is shown in FIG. 7.

When the multi-media device 12 is received in the multi-media support 15, the forward facing surfaces 66, 68 can be substantially continuous with the display 18. That is, the forward facing surfaces 66, 68 generally follow the same contour of the display 18. Thus, in instances in which the display 18 is substantially planar, the forward facing surfaces 66, 68 can be substantially planar. Alternatively, in instances in which the display 18 is convex, the forward facing surfaces 66, 68 can be substantially convex, as is shown in FIGS. 7-8. More particularly, the curvature of the display 18 can be substantially identical to the curvature of the forward facing surfaces 66, 68.

In one implementation, the support 15 can be configured to engage the multi-media device 12. For instance, the first and/or second lateral elements 60, 62 of the support 15 can be configured to engage the multi-media device 12. More particularly, the inwardly facing lateral surfaces 70, 72 can be configured for engagement with the first and second lateral sides 19a, 19b of the multi-media device 12. As an example, there can be a substantially abutting engagement between the inwardly facing lateral surfaces 70, 72 and the first and second lateral sides 19a, 19b of the multi-media device 12. An example of substantially abutting engagement is shown in FIG. 8.

As another example, the inwardly facing lateral surfaces 70, 72 can be configured for interlocking and/or sliding engagement with the first and second lateral sides 19a, 19b of the multi-media device 12. In such case, the multi-media device can be prevented from moving forward, backward, laterally and/or down relative to the support 15. It should be noted that, alternatively or in addition to the above engagements, the connecting element 64 of the support 15 can be configured to engage the multi-media device 12.

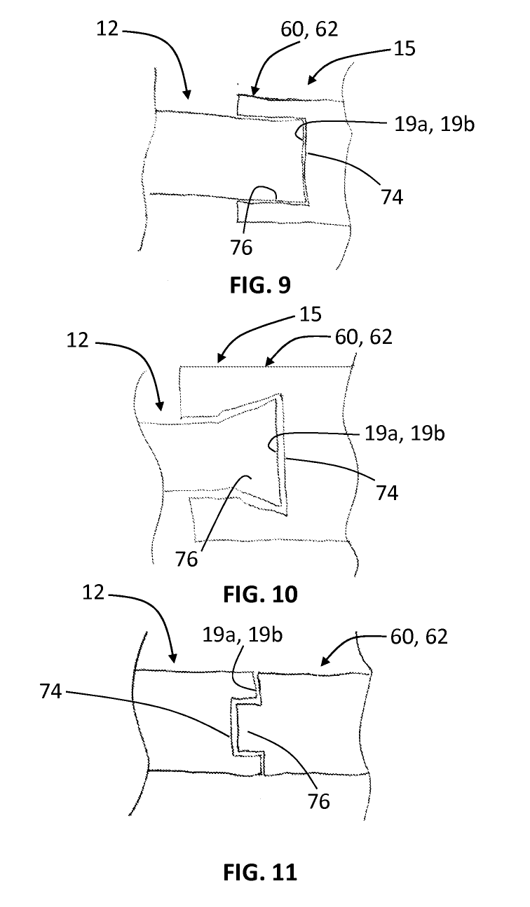

Various examples of interlocking and/or sliding engagement between the support 15 and the multi-media device 12 are shown in FIGS. 9-11. It will be understood that these examples are provided merely to facilitate the discussion and that arrangements are not limited to these examples. In one arrangement, the inwardly facing lateral surfaces 70, 72 can include a female portion 74 (e.g. a recess, groove, channel, etc.) to receive a corresponding male portion 76 of the multi-media device 12. The male portion 76 of the multi-media device 12 can include the lateral sides 19a, 19a. The female portion 74 can have any suitable shape, including, for example u-shaped (FIG. 8), v-shaped, dovetail (FIG. 10), etc. It will be understood that the inwardly facing lateral surfaces 70, 72 can include male portion 76 to be received in a corresponding female portion 74 of the multi-media device 12. An example of such an arrangement is shown in FIG. 11.

The multi-media support 15 can include one or more user input interfaces for receiving input from a user. Any suitable user input interface can be provided, including, for example, a keypad, display, touch screen, button, joystick, mouse, microphone or combinations thereof. The multi-media support 15 can include one or more outputs for presenting an output to the user. The outputs can also include a microphone, earphone and/or speaker. In one implementation, the first and/or second lateral elements 60, 62 can include one or more speakers 80. A “speaker” is defined as one or more devices or components that produce sound in response to an audio signal input. The speakers 80 can be any suitable type of speakers. In one example, the speakers 80 can include a subwoofer (e.g. a 6 inch subwoofer) and a bass speaker (e.g. a 10 inch bass speaker). Further examples of speakers include, for example, electroacoustic transducers, sound chips, and sound cards.

The multi-media support 15 may include a component interface. Additional elements can be operatively connected to the component interface, including, for example, a universal serial bus (USB) interface. The multi-media support 15 can provide a device interface 82 (FIGS. 3 and 4) configured for operative connection to the support interface 34 of the multi-media support 15. The device interface 82 can be any suitable type of connector. For instance, the device interface 82 can be any suitable type of audio connector.

The device interface 82 can be located so that when the multi-media device 12 engages the support 15 and/or is received in the support 15, the device interface 82 can be operatively connected to the support interface 34. In such a condition, one or more outputs from the multi-media device 12 can be received by the support 15 for output thereon. As an example, an audio output from the multi-media device 12 can be output via speakers 80 in the support 15.

Various examples of other inputs, outputs and/or controls that can be provided by the support 15 will now be described. Again, embodiments are not limited to these possibilities, as the support 15 can have all of these arrangements, a subset of these arrangements, or completely different arrangements. The support 15 can include a microphone, a remote locator, a motion sensor/power button and/or a Bluetooth connector or other connector. In some instances, these items may instead be provided on the multi-media device 12. In still other instances, all of these items or a subset thereof can be provided on the multi-media device 12 and/or the support 15.

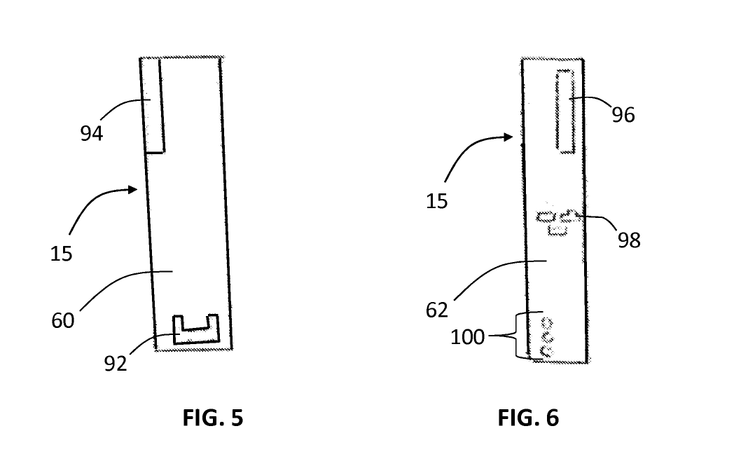

Further, the support 15 can include a remote charging port 92 and/or a rechargeable emergency battery 94, as is shown in FIG. 5. Still further, the support 15 can include a DVD or Blu-ray player 96, a portable device connector 98 and/or one or more inputs 100, as is shown in FIG. 6. FIGS. 5 and 6 show one possible arrangement of these various elements on the support 15, but it will be understood that this is merely an example, as the elements can be arranged on the support 15 in any suitable.

As noted above, the system 10 can include a remote control device 14. The remote control device 14 can be adapted to allow remote manipulation of at least some aspects of the multi-media device 12, the multi-media support 15 and/or the peripheral device 36. In some implementations, the remote control device 14 can include a display. The remote control device 14 can be any suitable device including, for example, a remote control, a cellular telephone, a smart phone, a personal digital assistant (“PDA”), a tablet computer, a digital reader, a handheld device having wireless connection capability, a computer (e.g., a laptop), a portable communication device, a portable computing device, an e-book reader, a camera or a game console. The remote control device 14 can be configured to communicate via a wireless or wired medium.

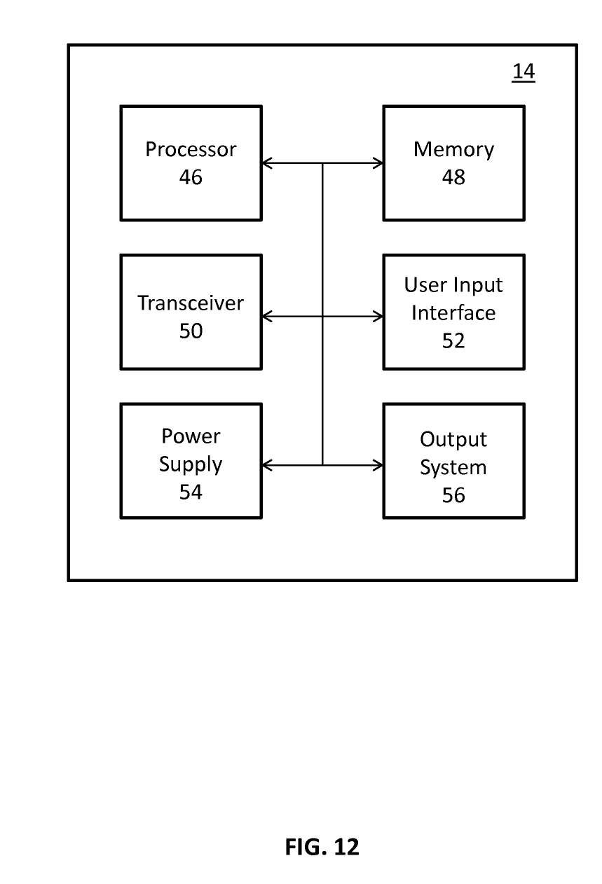

Referring to FIG. 12, an exemplary remote control device 14 is shown. The remote control device 14 can include a processor 46. The remote control device 14 may also include memory 48 for storing various types of data. The memory 14 can be operatively connected to the processor 12 for use thereby. The above-discussion of the processor 20 and memory 22 made in connection with the multi-media device 12 is equally applicable to the processor 46 and memory 48 of the remote control device 14.

The remote control device 14 can be operatively connected to the multi-media device 12, the multi-media support 15 and/or the peripheral device 36 to transmit data thereto and receive data therefrom. The operatively connection between the remote control device 14 and the multi-media device 12, the multi-media support 15 and/or the peripheral device 36 can be achieved in any suitable wired or wireless manner. In instances in which the remote control device 14 is operatively connected wirelessly to the multi-media device 12, the multi-media support 15 and/or the peripheral device 36, the remote control device 14 can further include a transceiver 50. The above-discussion of the transceiver 24 made in connection with the multi-media device 12 is equally applicable to the transceiver 50 of the remote control device 14. The transceiver 50 can be operatively connected to the processor 46 and/or the memory 48. The transceiver 50 of the remote control device 14 can transmit to and receive data from the transceiver 24 of the multi-media device, the transceiver of the peripheral device and/or a remote source.

The remote control device 14 can include a user input interface 52 for receiving input from a user and/or presenting information to the user. Any user input interface 52 can be used including a display, which can be a touch screen. The user input interface 52 may include additional elements, including, for example, a button, joystick, track ball, mouse or combinations thereof. The user input interface 52 may also include an audio interface that can include a microphone, earphone and/or speaker. The remote control device 14 can further include one or more motion sensors and/or a game control interface.

The remote control device 14 can be configured to access and/or execute application software thereon to enhance the user input interface 52. Such functionality can be provided by application software that is stored directly on the remote control device 14, such as in memory 48. Alternatively, the remote control device 14 can access and/or execute application software from an external source, such as the multi-media device 12, the peripheral device 36 and/or the remote source 34.

Now that the system for a multi-media device and various components thereof have been described, one manner of the using the system will now be described. Various possible steps will be described. The method may be applicable to the embodiments described above in relation to FIGS. 1-12, but it is understood that the method can be carried out with other suitable systems and arrangements. Moreover, the method may include other steps that are not described, and in fact, the method is not limited to including every step described herein. Moreover, the described steps are not limited to the particular chronological order described. Indeed, some of the steps may be performed in a different order than what is described and/or at least some of the steps shown can occur simultaneously.

The multi-media device 12 and the support 15 can be brought into engagement with each other. Such engagement can include the device connector 82 and the support connector 34 being operatively connected to each other. An output from the multi-media device 12 can be output on the support 15. In one arrangement, an audio output from the multi-media device 12 can be output on the support 15.

It will be appreciated that embodiments described herein can provide numerous benefits. Significantly, the support 15 can change the direction of the audio output from the multi-media device 12 to one that is preferred by the user. Further, because of the various technologies integrated into the support 15, the user can avoid having to connect a plurality of peripheral devices to the multi-media device 12. Still further, when the multi-media device is received in the support, an overall streamlined and/or attractive appearance can be provided. Still further, in instances in which the first and/or second lateral elements of the support are detachable from the connecting element, a user can place the speakers in a desired location to provide audio output from a location desired by the user. Overall, a user's enjoyment of and experience with the multi-media device 12 can be improved.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage medium, such as a computer-readable storage medium of a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

Aspects can be embodied in other forms without departing from the spirit or essential attributes thereof. Accordingly, reference should be made to the following claims, rather than to the foregoing specification, as indicating the scope of the invention.

What is claimed is:

1. A support for a multi-media device comprising:
a first lateral element housing a first speaker;
a second lateral element housing a second speaker; and
a connecting element joining the first and second lateral elements, the first and second lateral elements being spaced to receive a multi-media device therebetween, and the first and second lateral elements being configured to engage the multi-media device.

2. The support of claim 1, wherein the first and second lateral elements include a respective forward facing surface, wherein at least one of the forward facing surfaces is convex.

3. The support of claim 1, wherein the first speaker includes a subspeaker and a base speaker, and wherein the second speaker includes a subspeaker and a base speaker.

4. The support of claim 1, wherein the connecting element is removably attached to at least one of the first and second lateral elements.

5. The support of claim 1, wherein at least one of the first and second lateral elements includes a respective inwardly facing lateral surface, wherein at least one of the inwardly facing lateral surfaces is configured to interlockingly engage a multi-media device.

6. The support of claim 1, wherein the at least one of the inwardly facing lateral surfaces includes a male portion, whereby the male portion interlockingly engages a respective female portion of a multi-media device.

7. The support of claim 1, wherein the at least one of the inwardly facing lateral surfaces includes a female portion, whereby the female portion interlockingly engages a respective male portion of a multi-media device.

8. The support of claim 1, further including a connector configured to engage a respective connector provided on a multi-media device.

9. The support of claim 1, wherein the connecting element is angled at substantially 90 degrees relative to at least one of the first and second lateral elements.

10. A system comprising:
a multi-media device, the multi-media device including a support connector; and
a support for the multi-media device, the support including a first lateral element housing a first speaker, a second lateral element housing a second speaker, and a connecting element joining the first and second lateral elements, the first and second lateral elements being spaced to receive the multi-media device therebetween, the support including a device connector configured to operatively connect to the support connector on the multi-media device,
the device connector and the support connector being operatively connected so that audio output from the multi-media device is output from the first speaker and/or second speaker of the support.

11. The system of claim 10, wherein the multi-media device is a television.

12. The system of claim 10, wherein the first and second lateral elements include a respective forward facing surface, wherein at least one of the forward facing surfaces is convex.

13. The system of claim 12, wherein the multi-media device includes a display, wherein the display has an associated curvature, and wherein the curvature of the display substantially matches an associated curvature of the at least one convex forward facing surface.

14. The system of claim 10, wherein the connecting element is removably attached to at least one of the first and second lateral elements.

15. The system of claim 10, wherein each of the first and second lateral elements include a respective inwardly facing lateral surface, wherein at least one of the inwardly facing lateral surfaces is configured to interlockingly engage the multi-media device.

16. The system of claim 15, wherein one of the inwardly facing lateral surfaces includes a male portion, wherein the multi-media device includes a first lateral side and a second lateral side, wherein a respective one of the first and seconds lateral sides includes a female portion corresponding to the male portion, and wherein the male portion is received the female portion, whereby the multi-media device and the support are interlockingly engaged.

17. The system of claim 15, wherein one of the inwardly facing lateral surfaces includes a female portion, wherein the multi-media device includes a first lateral side and a second lateral side, wherein a respective one of the first and second lateral sides includes a male portion corresponding to the female portion, and wherein the male portion is received the female portion, whereby the multi-media device and the support are interlockingly engaged.

18. A method for a multi-media device, the multi-media device including a support connector, a support for the multi-media device being provided, the support including a first lateral element housing a first speaker, a second lateral element housing a second speaker, and a connecting element joining the first and second lateral elements, the first and second lateral elements being spaced to receive the multi-media device therebetween, the support including a device connector configured to operatively connect to the support connector on the multi-media device, the method comprising:
bringing the multi-media device and the support into engagement with each other such that the device connector and the support connector are operatively connected; and
outputting on the support an output from the multi-media device.

19. The method of claim 18, wherein the multi-media device is a television.

20. The method of claim 18, wherein outputting an output from the multi-media device on the support includes outputting on the support an audio output from the multi-media device.
